(19) United States
(12) Patent Application Publication
(10) Pub. No.: US 2024/0079914 A1
(43) Pub. Date: Mar. 7, 2024

(54) METHODS, SYSTEMS, AND PROGRAM PRODUCTS FOR DESKTOP CHARGING WITH CHARGE STATUS FEEDBACK

(71) Applicant: Lenovo (Singapore) Pte. Ltd., New Tech Park (SG)

(72) Inventors: John Travis Wettroth, Chapel Hil, NC (US); Samuel Patterson, Raleigh, NC (US); Kathryn Cubrilovic, Raleigh, NC (US); Brian William Wallace, Wake Forest, NC (US); Yoshihito Nakagaki, Yokohama-shi (JP)

(21) Appl. No.: 17/930,182

(22) Filed: Sep. 7, 2022

(51) Int. Cl. H02J 50/90; H02J 50/12; H02J 50/40; H02J 50/80

(52) U.S. Cl. CPC H02J 50/90; H02J 50/12; H02J 50/402; H02J 50/80; H02J 50/005

(57) ABSTRACT

Methods, systems, and tables are disclosed for charging multiple devices on a surface and providing feedback. An exemplary method includes sensing a location of a wirelessly rechargeable device on a charging surface of the wirelessly charging surface device and wirelessly powering the wirelessly rechargeable device via a portion of the charging surface corresponding to the sensed location of the wirelessly rechargeable device. The method also includes receiving charging status information from the wirelessly rechargeable device and outputting a human perceptible indication responsive to the received charging status information and the sensed location of the wirelessly rechargeable device.

### FIELD

The subject matter disclosed herein relates to wireless charging.

### BACKGROUND

Current wireless charge solutions are limited to small areas or specific configurations for devices.

### BRIEF SUMMARY

Methods, systems, and tables are disclosed for charging multiple devices on a surface and providing feedback.

A method, in one embodiment, includes sensing a location of a wirelessly rechargeable device on a charging surface of the wirelessly charging surface device and wirelessly powering the wirelessly rechargeable device via a portion of the charging surface corresponding to the sensed location of the wirelessly rechargeable device. The method also includes receiving charging status information from the wirelessly rechargeable device and outputting a human perceptible indication responsive to the received charging status information and the sensed location of the wirelessly rechargeable device.

A system, in one embodiment, includes: a charging surface comprising a plurality of charging coils; an output device; a controller in communication with the charging surface and the output device; and a storage device configured to store machine-readable instructions that, when executed by the controller, cause the controller to: receive location information of a wirelessly rechargeable device located on the charging surface; control a portion of the charging surface responsive to the location information of the wirelessly rechargeable device; receive charging status information from the wirelessly rechargeable device; and output a signal to the output device, wherein the output device is configured to produce a human perceptible indication responsive to the received charging status information and the received location information of the wirelessly rechargeable device.

A table, in one embodiment, includes a charging surface comprising a plurality of charging coils, an output device, a controller in communication with the charging surface and the output device; and a storage device. The storage device is configured to store machine-readable instructions, when executed by the controller, cause the table to receive location information of a wirelessly rechargeable device located on the charging surface, control a portion of the charging surface responsive to the location information of the wirelessly rechargeable device, receive charging status information from the wirelessly rechargeable device, and output a signal to the output device, wherein the output device is configured to produce a human perceptible indication responsive to the received charging status information and the received location information of the wirelessly rechargeable device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be limiting of scope, the embodiments will be described and explained with additional specificity and detail using the accompanying drawings, in which:

FIG. 1 is a schematic block diagram illustrating a wireless charging environment;

FIG. 2 is a cross-sectional view of a portion of a wireless charging device;

FIG. 3 is a perspective view of a wireless charging device in a first operational mode;

FIG. 4 is a perspective view of a wireless charging device in a second operational mode;

FIG. 5 is a perspective view of a wireless charging device in a third operational mode;

FIG. 6 is a schematic flow chart diagram illustrating one embodiment of a method for wireless charging a device;

FIG. 7 is a schematic flow chart diagram illustrating an additional embodiment of the method of FIG. 6;

FIG. 8 is a schematic flow chart diagram illustrating an additional embodiment of the method of FIG. 6; and

FIG. 9 is a schematic flow chart diagram illustrating an additional embodiment of the method of FIG. 6.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, to emphasize their implementation independence more particularly. For example, a module may be implemented as a hardware circuit comprising custom very large scale integrated (VLSI) circuits or gate arrays, off-the-shelf semiconductors such as logic chips, transistors, or other discrete components. A module may also be implemented in programmable hardware devices such as a field programmable gate array (FPGA), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an electrically erasable programmable read-only memory (EEPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Surface Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The apparatuses, methods, systems, program products, and their respective embodiments disclosed herein wirelessly charges rechargeable electronic devices on a table while providing charge status feedback. The description of elements in each figure may refer to elements of proceeding figures. Like numbers refer to like elements in all figures, including alternate embodiments of like elements.

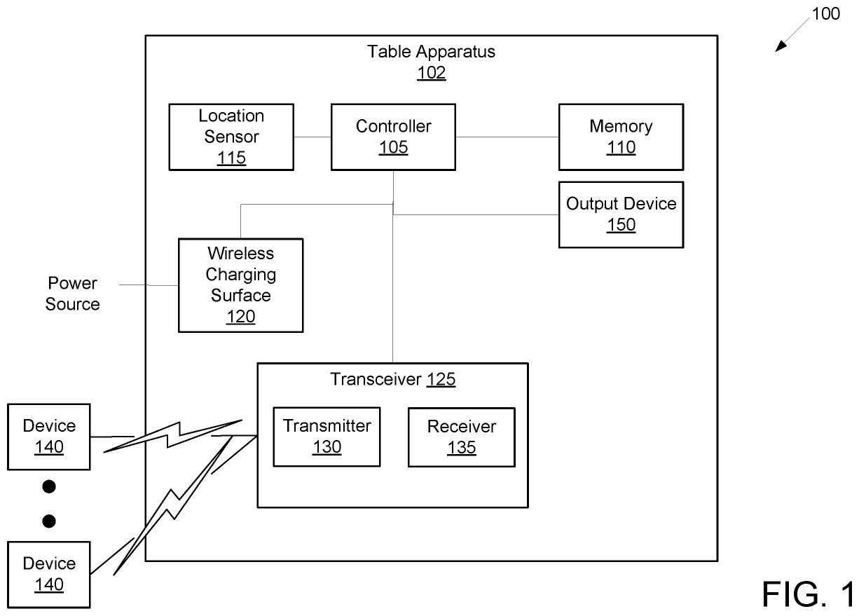

Referring to FIG. 1, in various embodiments, a wireless charging environment 100 includes a charging table apparatus 102 that is configured to charge one or more rechargeable devices 140. The table apparatus 102 includes a controller 105, a memory 110, a location sensor 115, a wireless charging component 120, a transceiver 125, and an output device 150. The transceiver 125 includes a transmitter 130 and a receiver 135. The table apparatus 102 is configured to wirelessly charge the rechargeable devices 140 at nearly any location on the wireless charging component 120 (i.e., full surface charging). Computer-readable instructions/code stored in the memory 110, when executed by the controller 105, cause the controller 105 to control where power is outputted by the wireless charging component 120 based on information of a location of the rechargeable device 140 on the wireless charging component 120. Thus, the table apparatus 102 is capable of allowing the rechargeable device 140 to be placed on nearly any part of the wireless charging component 120, whereby wireless power produced by components in the wireless charging component 120 are activated in the location associated with where the rechargeable device 140 is placed—not the whole surface. The instructions also cause the controller 105 to control amount of power applied to components of the wireless charging component 120. The location information is received from the location sensor 115.

The wireless charging component 120 includes a plurality of separately controllable coils that receive power/current from a power source, such as alternating current (AC) from an AC generator or power grid or direct current (DC) from a battery or DC generator. The wireless charging component 120 is in communication with the controller 105 which controls the power sent to the separately controllable coils. The separately controllable coils are selectively activated based on the location information received from the location sensor 115, e.g., for a respective rechargeable device 140. In one embodiment, the wireless charging component 120 includes a set of coils that can be selectively activated to charge one or more rechargeable devices 140 using wireless inductive charge pattern(s). In another embodiment, the wireless charging component 120 includes a set of coils that can be selectively activated to charge one or more rechargeable devices 140 using magnetic coupling charge pattern(s) (i.e., magnetic (loose) resonant charging). While specific examples of wireless charging technologies are described, the present disclosure should not be considered limited to these specific wireless charging technologies or any specific charging protocol or standard. Rather, the solutions for wireless charging of multiple devices on a surface and providing feedback described herein apply to any known wireless charging technology and charging protocol/standard.

In various embodiments, the instructions cause the controller 105 to receive charging status information of the rechargeable device 140 via the transceiver 125. Charging status information may be any information that indicates status of a charge (e.g., percentage, stored power, or the like) of rechargeable battery(ies) included in the rechargeable device 140. Responsive to receiving the charging status information, the instructions cause the controller 105 to generate an output image or an output signal that is sent to the output device 150. In response to receiving the output image or the output signal, the output device 150 produces a human perceptible indication associated with the charge status information. The human perceptible indications are also produced in accordance with the location information of the respective rechargeable device 140 relative to the wireless charging component 120. Thus, the location information of each respective rechargeable device 140 is translated to a region or area of the output device 150, such that a respective human perceptible indication for each rechargeable device 140 is presented at/from a portion of the output device 150 that corresponds to the location of the rechargeable device 140 relative to the rechargeable device 140. Human perceptible indications include any output that can be perceived by a user—audio, visual, or tactile. In some embodiments, the output of the output device 150 may be visual indication, an audible indication, or a combination thereof.

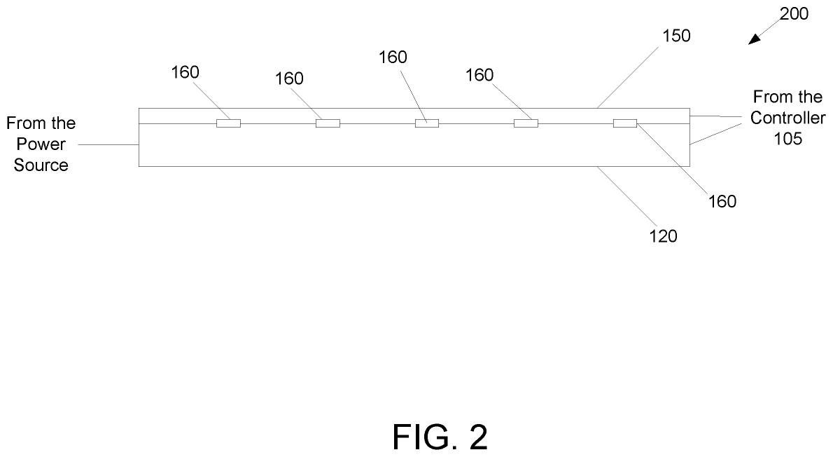

In various embodiments, referring to FIG. 2, a cross-sectional view of a combination device 200 is shown, according to embodiments of the disclosure. The combination device 200 may be an implementation of the charging table apparatus 102 and/or the wireless charging component 120. The combination device 200 includes the output device 150 in a top layer mounted to the wireless charging component 120 in a layer below the top layer. The location sensor 115 (FIG. 1) may include optional pressure sensors 160 that are located between the top layer and the lower layer. The pressure sensors 160 sense weight of the rechargeable device 140 when placed on the top layer. The pressure sensors 160 provide pressure information (i.e., touch points relative to the wireless charging component 120) that is sent to the controller 105. When the rechargeable device 140 is placed with on top of the combination device 200, the pressure sensors 160 produce different pressure information, thus allowing the controller 105 to determine where the rechargeable device 140 is located relative to the wireless charging component 120.

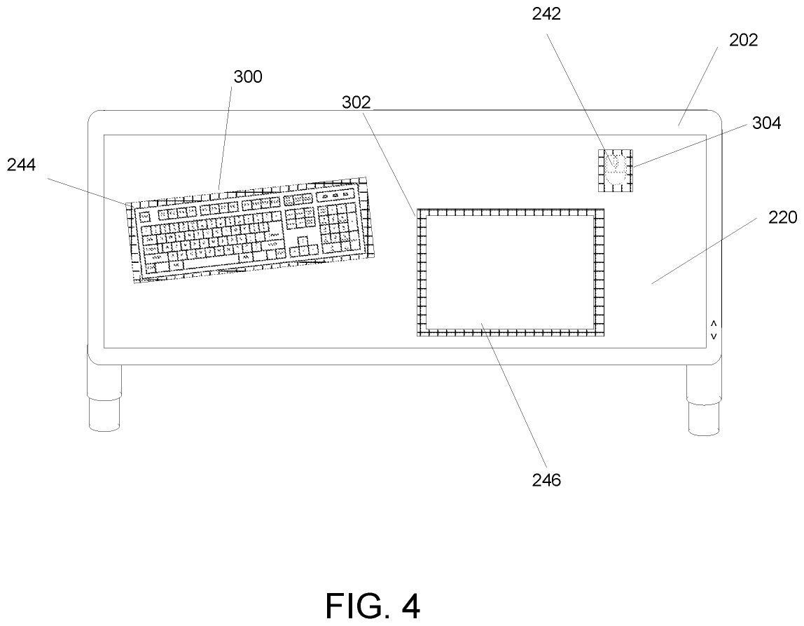

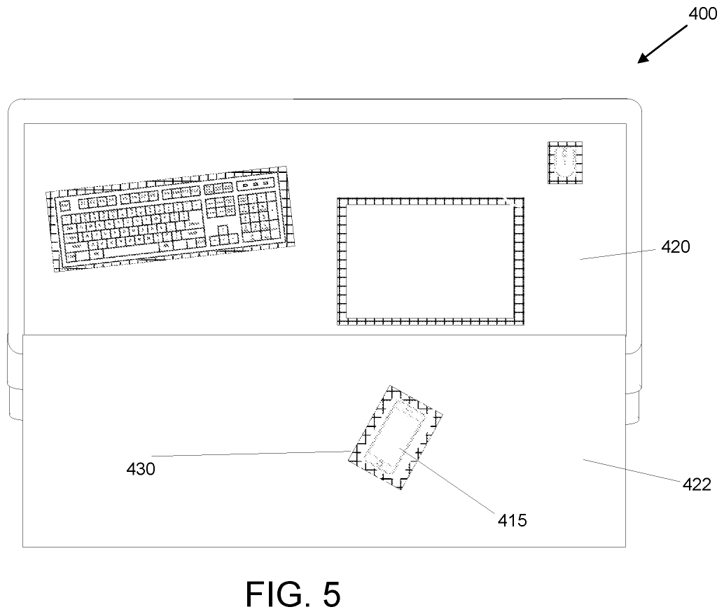

In various embodiments, the output device 150 includes a plurality of light-emitting diodes (LEDs) or other light emitting devices that are separately controllable by the controller 105. In some embodiments, the LEDs are attached to or suspended within a material that is non-conductive and magnetically permeable. In other embodiments, the output device 150 is located remote from the table apparatus 102, such as a light source or a projector configured to generate a light indication or an image at or near the location of the rechargeable device 140 on the substantially larger wireless charging component 120 in order for multiple rechargeable devices 140 to be charged simultaneously by the wireless charging component 120. As described above, the location of each light indication or image may be derived from location information corresponding to each rechargeable device 140. The output device 150 may communicate with the controller 105 via a wired or wireless connection via the transceiver 125. In some embodiments, the output device 150 may include a visual indication device (such as a display screen, a monitor, a touchscreen, virtual reality (VR) glasses, VR goggles, augmented reality (AR) glasses, AR goggles, a head mounted display (HMD)), an audio producing device (e.g., speakers), a tactile producing device (e.g., vibrator), etc. The controller 105 controls operations of the output device 150 according to location information of the rechargeable devices 140. This is described below with regard to FIGS. 4 and 5.

In various embodiments, before and/or after charging begins, a handshake communication operation may be performed between the rechargeable device 140 and the controller 105. A handshake communication operation is an automated process for information exchange between a respective rechargeable device 140 and the controller 105. In certain embodiments, the handshake communication operation occurs before charging (i.e., wireless power transfer) to verify compatibility. During the handshake communication operation, the controller 105 receives, via the transceiver 125, various information about the rechargeable device 140. The received information may include device type (e.g., smartphone, mouse, keyboard, laptop computer, etc.), make, model, dimension information, battery charge value (e.g., level of charge), amount of charge required (i.e., how much charging of the batteries is needed for the rechargeable device 140), size of charging pattern (i.e., how large a charging pattern to produce), charging speed type capability (e.g., fast or normal), and/or charging capacity. The charging pattern shape and size (i.e., power level) is determined by what coils are activated and what current level is applied to the activated coils. The device type may indicate the actual device type (e.g., smartphone, laptop) or the size, shape, number, and/or orientation of the charging components of the rechargeable device 140. Additionally, the controller 105 and/or the location sensor 115 may calculate location information of the rechargeable device 140 based on size and shape information either received directly from the rechargeable device 140 via the handshake or retrieved from a database of dimensions previously stored in the memory 110. Additional handshake communication operations may occur between the same rechargeable device 140 and the controller during charging as certain information—such as battery charge level—is expected to change as the charging operation progresses. In certain embodiments, the handshake communication operation is triggered when the controller 105 determines that an object is placed on (or above) the wireless charging component 120. Here, the handshake communication operation may be used to verify that the detected object is a rechargeable device 140. In certain embodiments, the handshake communication operation is integrated with the procedure for determining location information of a rechargeable device 140. For example, signals used to determine the location information may also be used to initiate or perform the handshake communication operation, or signals used to initiate or perform the handshake communication operation may also be used to determine the location information.

In various embodiments, the instructions cause the controller 105 to display alphanumeric characters at the output device 150. The alphanumeric characters may include a charge percentage (i.e., battery charge value) or comparable number that is presented at a location of the wireless charging component 120 next to the respective wireless charging device based on the information (e.g., battery charge value, rechargeable device information, such as shape) received from the respective rechargeable device 140 and the location information received from the location sensor 115.

In various embodiments, the rechargeable devices 140 include mobile phones, tablet computers (pad), laptop computers, palmtop computers, mobile internet devices (MID), wearable devices, virtual reality (VR) devices, augmented reality (AR) devices, personal digital assistants (PDA), handheld devices, accessory devices (including mouse, electronic stylus, and/or keyboard), computing devices or another processing devices, and/or any other suitable device configured to include wireless charging capabilities. This is not limited in embodiments of this application.

The controller 105 may include any type of processing device, such as a microprocessor, a microcontroller, a central processing unit (CPU), a graphics processing unit (GPU), an auxiliary processing unit (APU), an FPGA, another processing device, or any component capable of executing machine-readable instructions for performing data processing according to the instructions. The memory 110 may include volatile and/or non-volatile memory, examples of which may include, but are not limited to, RAM, dynamic RAM (DRAM), synchronous DRAM (SDRAM), ROM, hard disk drive (HDD) device, and/or solid-state storage (SSD) device.

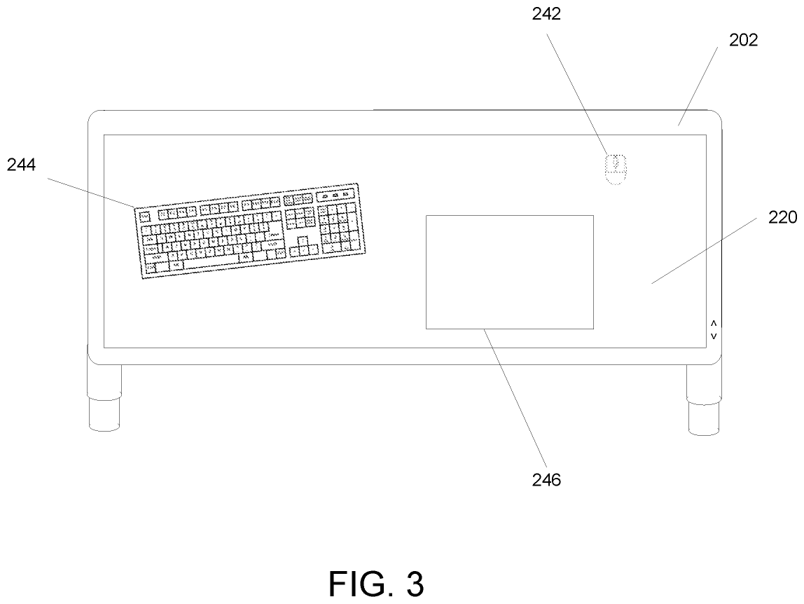

In various embodiments, referring to FIG. 3, a laptop 246, a mouse 242, and a keyboard 244 are initially placed on a charging surface/output device 220 (similar to a combination of the wireless charging component 120 and output device 150 of FIG. 1) of a table apparatus 202 (similar to the table apparatus 102 of FIG. 1). The laptop 246, the mouse 242, and keyboard 244 may be implementations of the rechargeable devices 140 and include wireless recharging components compatible with wireless recharging components within the charging surface/output device 220. The table apparatus 202 detects presence of an object, if the object is a wireless charging device, and identifies where the wireless charging device (the laptop 246, the mouse 242, and keyboard 244) is located on the charging surface/output device 220. The table apparatus 202 includes a (grid) location sensor(s) (similar to the location sensor 115 of FIG. 1) that may include any combination of pressure sensors, ultra-wideband radio frequency transceivers configured to communicate with transceivers located in the wireless charging devices, light/laser grid sensors, infrared sensors, external pattern recognition devices (e.g., a camera device), comparable location sensing devices, or a combination of sensors in a camera vision system. In some embodiments, the table apparatus 202 is a component of a larger system that include the external pattern recognition devices (including one or more camera devices), a remote output device, and the like, where the various system components are communicatively couple and configured to perform the charging and indication techniques described herein. In one embodiment, the table apparatus 202 is capable of comparing sensor signals (e.g., images, distance values) of the wireless charging devices to known dimensions of the charging surface/output device 220 to determine location (e.g., x-y coordinates) of the wireless charging devices on the charging surface/output device 220. In another embodiment, the table apparatus 202 includes a grid location device, such as light/laser grid sensors, that produces product size information for the wireless charging devices and/or grid location information of the wireless charging devices (i.e., location within a grid superimposed on a surface of the table apparatus 202), thereby allowing the table apparatus 202 to determine location of the wireless charging devices on the charging surface/output device 220 due to the size and shape of the charging surface/output device 220 being a known value. Before, after, or simultaneously with identifying location of the wireless charging devices, the table apparatus 202 receives an indication that a device that is present on the charging surface/output device 220 is one that is configured to be recharged and/or needs a recharge as indicated via a handshake procedure. If, for example, the device is a pencil, the pencil would not be capable of sending any indication via the handshake procedure and thus would not be in need of a charge.

Referring now to FIG. 4, after the table apparatus 202 has identified the locations of the wireless charging devices on the charging surface/output device 220, charging and feedback begin. Based upon the identified locations of the wireless charging devices, the wireless charging components of the charging surface/output device 220 is instructed by the table apparatus 202 to simultaneously generate charge patterns/magnetic fields, using separately controllable coils in one example, according to location information received from the location sensor for the device(s) 242-246 that are in need of charging. Accordingly, the table apparatus 202 may concurrently charge multiple wirelessly rechargeable devices present on the charging surface/output device 220. Similar to the charging table apparatus 102, the wireless charging components in the table apparatus 202 may be activated only in areas where the device(s) 242-246 in need of charging are positioned, such that other wireless charging components in the table apparatus 202 remain unpowered or deactivated. Moreover, multiple coils may be activated for a single rechargeable device, e.g., to achieve a higher charging voltage and/or charging rate for a rechargeable device 140 having large capacity and/or higher voltage battery. For example, the laptop 246 may comprise a significantly higher capacity and higher voltage battery compared to the mouse 242 and keyboard 244. Therefore, the laptop 242 may comprise multiple inductive charging coils to facilitate effective charging its battery and the table apparatus 202 may activate a corresponding number of inductive charging coils located near the laptop 246. The table apparatus 202 also instructs output components (similar to the output device 150 of FIG. 1) of the charging surface/output device 220 to illuminate patterns 300, 302, 304 (i.e., human perceptible indications) around the edges of the wireless charging devices, such as, without limitation, a border, an outside ring, a lighting ring, based on the identified locations of the respective wireless charging devices. In various embodiments, illumination at or near the location of the wireless charging devices on the charging surface/output device 220 may provide a variety of information. For example, the illumination may indicate a level of charge of the respective wireless charging device responsive to communication of charge value information communicated from the respective wireless charging device. For example, the illumination may be a first color when the level of charge of the respective wireless charging device is below a first threshold value and is a second color when the level of charge is above the first threshold value. The illumination of lights may also blink at a first rate if the level of charge is below the first threshold value and at a second rate if the level of charge is above the first threshold value. In one embodiment, the illumination may use a particular color to indicate that the wireless charging is complete (e.g., green) and may use a different color to indicate that the wireless charging inactive/in progress (e.g., red). The illumination may be presented at a location on the charging surface/output device 220 at some distance greater than the dimensions of the device under charge. For example, the illumination occurs about 20 mm outside of the determined dimensions of the device under charge. As mentioned above the dimensions may be determined by the handshake operation, the locations sensors (e.g., cameras or laser sensors) and/or pressure/weight sensors.

In various embodiments, different ways of illuminating the charging surface/output device 220 may also be performed by a remotely located light source/projector device (not shown). The light source/projector device may be staged above the charging table apparatus 202 for illuminating the charging surface/output device 220 based on the same information described above.

In various embodiments, different ways of illuminating the charging surface/output device 220 may also be performed by using an augmented reality (AR) device. The AR device may be worn by a user for presenting images that are only viewable by the user. The presented images illuminate a location at or near the charging surface/output device 220 based on the same information described above.

In various embodiments, referring to FIG. 5, a charging table 400 includes a second charging surface/output device 422 (similar to a combination of the wireless charging surface 120 and the output device 150) that is slidably received from under a first charging surface/output device 420 (similar to a combination of the wireless charging surface 120 and the output device 150). The second charging surface/output device 422 is in a deactivated state when stowed under the first charging surface/output device 420. The second charging surface the second charging surface/output device 422 is in an activated state after becoming unstowed and moved into place as shown in FIG. 5. The second charging surface/output device 422, based on signals received from the controller, produces an illumination pattern 430 relative to a wireless rechargeable device 415, similar to patterns 300, 302, 304 produced on the first charging surface/output device 420, shown in FIG. 4.

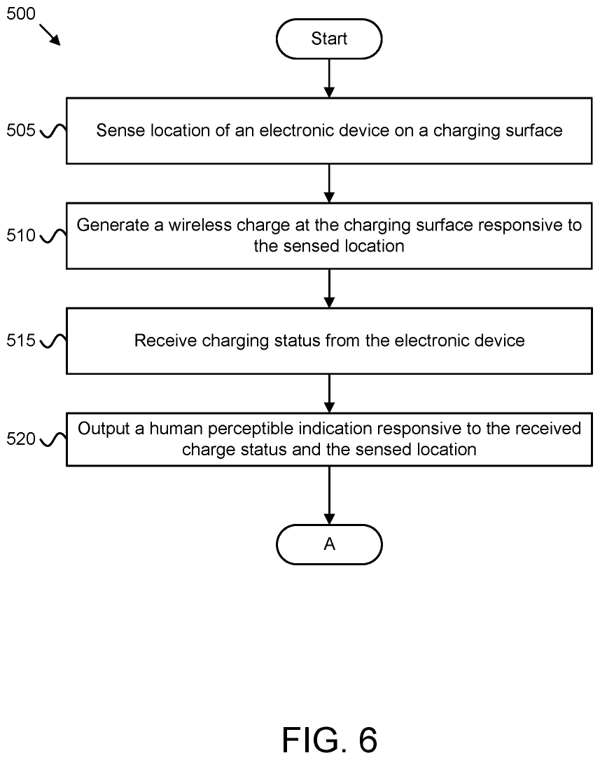

In various embodiments, in FIG. 6 is a schematic flow chart diagram illustrating an embodiment of a method 500 for providing charging to one or more devices with charging feedback in a full surface charging environment. In certain embodiments, the method 500 may be performed by a processor executing program code, for example, a microcontroller, a microprocessor, a CPU, a GPU, an APU, an FPGA, or the like. At a block 505, location of an electronic device on a charging surface of a wirelessly charging surface device is sensed. At a block 510, a wireless charge is generated at a charging surface responsive to the sensed location of the electronic device. At a block 515, any of various types of charging status information is received from the electronic device. At a block 520, a human perceptible indication is outputted responsive to the received charge status information and the sensed location of the wirelessly rechargeable device.

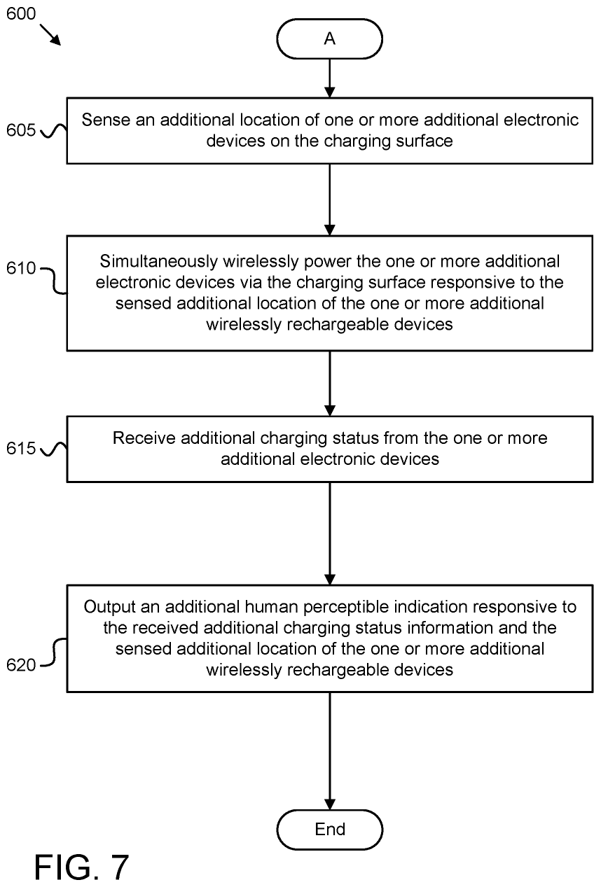

In various embodiments, in FIG. 7 is a schematic flow chart diagram illustrating an embodiment of a method 600 for providing charging to additional devices with charging feedback in a full surface charging environment. At a block 605, additional location of one or more additional electronic devices on the charging surface is sensed. At a block 610, the one or more additional electronic devices are simultaneously wirelessly powered via the charging surface responsive to the sensed additional location of the one or more additional wirelessly rechargeable devices. At a block 615, additional charging status from the one or more additional electronic devices is received. At a block 620, an additional human perceptible indication is outputted responsive to the received additional charging status information and the sensed additional location of the one or more additional wirelessly rechargeable devices. The method 600 may be performed after the method 500 or concurrently with the method 500.

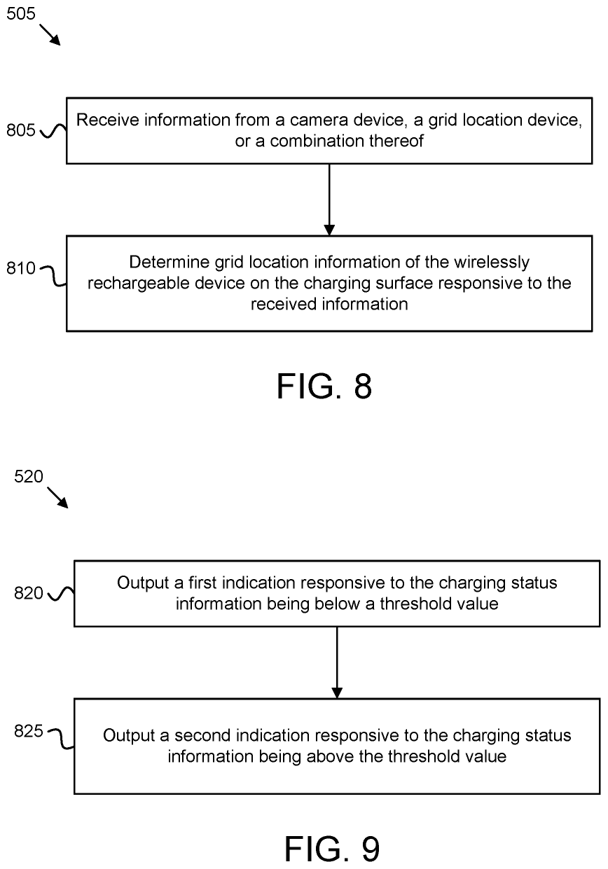

In various embodiments, in FIG. 8 is a schematic flow chart diagram illustrating further details of the block 505 of FIG. 6. At a block 805, information is received from a camera device, a grid location device, or a combination thereof. At a block 810, grid location information of the wirelessly rechargeable device on the charging surface is determined responsive to the received information.

In various embodiments, in FIG. 9 is a schematic flow chart diagram illustrating further details of the block 520 of FIG. 6. At a block 820, a first indication is outputted responsive to the charging status information being below a threshold value. At a block 825, a second indication is outputted responsive to the charging status information being above the threshold value.

### Embodiments

A. A method performed at a wirelessly charging surface device, the method comprising: sensing a location of a wirelessly rechargeable device on a charging surface of the wirelessly charging surface device; wirelessly powering the wirelessly rechargeable device via a portion of the charging surface corresponding to the sensed location of the wirelessly rechargeable device; receiving charging status information from the wirelessly rechargeable device; and outputting a human perceptible indication responsive to the received charging status information and the sensed location of the wirelessly rechargeable device, wherein the human perceptible indication comprises a value indicating a position relative to the charging surface, the value indicating the relative position is based on the sensed location of the wirelessly rechargeable device.

B. The method of A, wherein wirelessly powering comprises controlling power to one or more charging coils of the wireless charging surface device.

C. The method of A or B, wherein wirelessly powering comprises performing inductive coupling charging, magnetic resonant coupling charging, or a combination thereof.

D. The method of any of A-C, further comprising: sensing an additional location of one or more additional wirelessly rechargeable devices on the charging surface of the wirelessly charging surface device; simultaneously wirelessly powering the one or more additional wirelessly rechargeable devices via the charging surface responsive to the sensed additional location of the one or more additional wirelessly rechargeable devices; receiving additional charging status information from the one or more additional wirelessly rechargeable devices; and outputting an additional human perceptible indication responsive to the received additional charging status information and the sensed additional location of the one or more additional wirelessly rechargeable devices, wherein the additional human perceptible indication comprises an additional value indicating an additional position relative to the charging surface, wherein the additional value is based on the sensed additional location of the one or more additional wirelessly rechargeable devices.

E. The method of any of A-D, wherein sensing comprises: receiving information from a camera device, a grid location device, or a combination thereof; and determining grid location information of the wirelessly rechargeable device on the charging surface responsive to the received information.

F. The method of any of A-E, wherein the human perceptible indication comprises a visual indication, an audible indication, or a combination thereof.

G. The method of any of A-F, wherein outputting the human perceptible indication comprises: outputting a first indication responsive to the charging status information being below a threshold value; and outputting a second indication responsive to the charging status information being above the threshold value.

H. The method of any of any of A-G, wherein wirelessly powering is performed via a full area of the charging surface.

I. A system comprising: a charging surface comprising a plurality of charging coils; an output device; a controller in communication with the charging surface and the output device; and a storage device configured to store machine-readable instructions that, when executed by the controller, cause the controller to: receive location information of a wirelessly rechargeable device located on the charging surface; control a portion of the charging surface responsive to the location information of the wirelessly rechargeable device; receive charging status information from the wirelessly rechargeable device; and output a signal to the output device, wherein the output device is configured to produce a human perceptible indication responsive to the received charging status information, wherein the signal comprises a value indicating a location relative to the charging surface, the value indicating the location is based on the received location information of the wirelessly rechargeable device.

J. The system of I, wherein the instructions further cause the controller to transfer power to the wirelessly rechargeable device via one or more of the plurality of charging coils responsive to the location information.

K. The system of I or J, wherein the one or more of the charging coils performs inductive coupling charging, magnetic resonant coupling charging, or a combination thereof.

L. The system of any of I-K, wherein the instructions further cause the controller to: receive additional location information of one or more additional wirelessly rechargeable devices on the charging surface; simultaneously control an additional portion of the charging surface responsive to the received additional location information of the one or more additional wirelessly rechargeable devices; receive additional charging status information from the one or more additional wirelessly rechargeable devices; and output an additional signal to the output device, wherein the output device is configured to produce an additional human perceptible indication responsive to the received additional charging status information and the received additional location information of the one or more additional wirelessly rechargeable devices.

M. The system of any of I-L, further comprising a camera device, a grid location device, or a combination thereof configured to produce the location information.

N. The system of any of I-M, wherein the output device comprises a visual indication device, a speaker, or a combination thereof.

O. The system of any of I-N, wherein the output device is configured to output a first indication responsive to the charging status information being below a first threshold value and output a second indication responsive to the charging status information being above the first threshold value.

P. A table comprising: a charging surface comprising a plurality of charging coils; an output device; a controller in communication with the charging surface and the output device; and a storage device configured to store machine-readable instructions, when executed by the controller, cause the table to: receive location information of a wirelessly rechargeable device located on the charging surface; control a portion of the charging surface responsive to the location information of the wirelessly rechargeable device; receive charging status information from the wirelessly rechargeable device; and output a signal to the output device, wherein the output device is configured to produce a human perceptible indication responsive to the received charging status information, wherein the signal comprises a value indicating a location relative to the charging surface, the value indicating the location is based on the received location information of the wirelessly rechargeable device.

Q. The table of P, wherein the instructions further cause the controller to transfer power to the wirelessly rechargeable device via one or more of the charging coils responsive to the location information.

R. The table of Q, wherein the one or more of the charging coils performs inductive coupling charging, magnetic resonant coupling charging, or a combination thereof.

S. The table of any of P-R, wherein the instructions further cause the controller to: receive additional location information of one or more additional wirelessly rechargeable devices on the charging surface; simultaneously control an additional portion of the charging surface responsive to the received additional location information of the one or more additional wirelessly rechargeable devices; receive additional charging status information from the one or more additional wirelessly rechargeable devices; and output an additional signal to the output device, wherein the output device is configured to produce an additional human perceptible indication responsive to the received additional charging status information and the received additional location information of the one or more additional wirelessly rechargeable devices, wherein the additional signal comprises an additional location value associated with the charging surface and the received additional location information of the one or more additional wirelessly rechargeable devices.

T. The table of any of P-S, wherein: the output device comprises a visual indication device, a speaker, or a combination thereof; and the output device is configured to output a first indication responsive to the charging status information being below a first threshold value and output a second indication responsive to the charging status information being above the first threshold value.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method performed at a wirelessly charging surface device, the method comprising:
sensing a location of a wirelessly rechargeable device on a charging surface of the wirelessly charging surface device;
wirelessly powering the wirelessly rechargeable device via a portion of the charging surface corresponding to the sensed location of the wirelessly rechargeable device;
receiving charging status information from the wirelessly rechargeable device; and
outputting a human perceptible indication responsive to the received charging status information and the sensed location of the wirelessly rechargeable device.

2. The method of claim 1, wherein wirelessly powering comprises controlling power to one or more charging coils of the wireless charging surface device.

3. The method of claim 1, wherein wirelessly powering comprises performing inductive coupling charging, magnetic resonant coupling charging, or a combination thereof.

4. The method of claim 1, further comprising:
sensing an additional location of one or more additional wirelessly rechargeable devices on the charging surface of the wirelessly charging surface device;
simultaneously wirelessly powering the one or more additional wirelessly rechargeable devices via the charging surface responsive to the sensed additional location of the one or more additional wirelessly rechargeable devices;
receiving additional charging status information from the one or more additional wirelessly rechargeable devices; and
outputting an additional human perceptible indication responsive to the received additional charging status information and the sensed additional location of the one or more additional wirelessly rechargeable devices.

5. The method of claim 1, wherein sensing comprises:
receiving information from a camera device, a grid location device, or a combination thereof; and
determining grid location information of the wirelessly rechargeable device on the charging surface responsive to the received information.

6. The method of claim 1, wherein the human perceptible indication comprises a visual indication, an audible indication, or a combination thereof.

7. The method of claim 6, wherein outputting the human perceptible indication comprises:
outputting a first indication responsive to the charging status information being below a threshold value; and
outputting a second indication responsive to the charging status information being above the threshold value.

8. The method of claim 1, wherein wirelessly powering is performed via a full area of the charging surface.

9. A system comprising:
a charging surface comprising a plurality of charging coils;
an output device;
a controller in communication with the charging surface and the output device; and
a storage device configured to store machine-readable instructions that, when executed by the controller, cause the controller to:
receive location information of a wirelessly rechargeable device located on the charging surface;
control a portion of the charging surface responsive to the location information of the wirelessly rechargeable device;
receive charging status information from the wirelessly rechargeable device; and
output a signal to the output device, wherein the output device is configured to produce a human perceptible indication responsive to the received charging status information and the received location information of the wirelessly rechargeable device.

10. The system of claim 9, wherein the instructions further cause the controller to transfer power to the wirelessly rechargeable device via one or more of the plurality of charging coils responsive to the location information.

11. The system of claim 10, wherein the one or more of the charging coils performs inductive coupling charging, magnetic resonant coupling charging, or a combination thereof.

12. The system of claim 9, wherein the instructions further cause the controller to:
receive additional location information of one or more additional wirelessly rechargeable devices on the charging surface;
simultaneously control an additional portion of the charging surface responsive to the received additional location information of the one or more additional wirelessly rechargeable devices;
receive additional charging status information from the one or more additional wirelessly rechargeable devices; and
output an additional signal to the output device, wherein the output device is configured to produce an additional human perceptible indication responsive to the received additional charging status information and the received additional location information of the one or more additional wirelessly rechargeable devices.

13. The system of claim 9, further comprising a camera device, a grid location device, or a combination thereof configured to produce the location information.

14. The system of claim 9, wherein the output device comprises a visual indication device, a speaker, or a combination thereof.

15. The system of claim 14, wherein the output device is configured to output a first indication responsive to the charging status information being below a first threshold value and output a second indication responsive to the charging status information being above the first threshold value.

16. A table comprising:
a charging surface comprising a plurality of charging coils;
an output device;
a controller in communication with the charging surface and the output device; and
a storage device configured to store machine-readable instructions, when executed by the controller, cause the table to:
receive location information of a wirelessly rechargeable device located on the charging surface;
control a portion of the charging surface responsive to the location information of the wirelessly rechargeable device;
receive charging status information from the wirelessly rechargeable device; and
output a signal to the output device, wherein the output device is configured to produce a human perceptible indication responsive to the received charging status information and the received location information of the wirelessly rechargeable device.

17. The table of claim 16, wherein the instructions further cause the controller to transfer power to the wirelessly rechargeable device via one or more of the charging coils responsive to the location information.

18. The table of claim 17, wherein the one or more of the charging coils performs inductive coupling charging, magnetic resonant coupling charging, or a combination thereof.

19. The table of claim 16, wherein the instructions further cause the controller to:
receive additional location information of one or more additional wirelessly rechargeable devices on the charging surface;
simultaneously control an additional portion of the charging surface responsive to the received additional location information of the one or more additional wirelessly rechargeable devices;
receive additional charging status information from the one or more additional wirelessly rechargeable devices; and
output an additional signal to the output device, wherein the output device is configured to produce an additional human perceptible indication responsive to the received additional charging status information and the received additional location information of the one or more additional wirelessly rechargeable devices.

20. The table of claim 16, wherein:
the output device comprises a visual indication device, a speaker, or a combination thereof; and
the output device is configured to output a first indication responsive to the charging status information being below a first threshold value and output a second indication responsive to the charging status information being above the first threshold value.
